(19) United States
(12) Patent Application Publication
(10) Pub. No.: US 2021/0350793 A1
(43) Pub. Date: Nov. 11, 2021

(54) CUSTOMER SERVICE SUPPORT DEVICE, CUSTOMER SERVICE SUPPORT METHOD, RECORDING MEDIUM WITH CUSTOMER SERVICE SUPPORT PROGRAM STORED THEREIN

(71) Applicant: NEC CORPORATION, Tokyo (JP)

(72) Inventor: Takayuki YUASA, Tokyo (JP)

(73) Assignee: NEC CORPORATION, Tokyo (JP)

(21) Appl. No.: 16/963,371

(22) PCT Filed: Feb. 18, 2019
(86) PCT No.: PCT/JP2019/005801

§ 371 Date: Jul. 20, 2020

(30) Foreign Application Priority Data
Feb. 20, 2018 (JP) 2018-028137

(51) Int. Cl. G10L 15/06; H04L 12/58; G06Q 30/00; G10L 15/22; G06K 9/00

(52) U.S. Cl. CPC G10L 15/063; H04L 51/02; G06Q 30/016; G10L 2015/0631; G06K 9/00302; G10L 2015/228; G10L 15/22

(57) ABSTRACT

A customer service support device includes: an acquisition unit for acquiring customer service information representing a content of a conversation made between a customer and a customer-service-handling-person and representing a state of the customer-service-handling-person; a calculation unit for calculating a similarity level between past case information representing a past case concerning the conversation and the customer service information representing a content of the conversation; a diagnosis unit for diagnosing a state of the customer-service-handling-person, based on diagnosis criterion information serving as a criterion when diagnosing the state of the customer-service-handling-person, and based on the customer service information; and a generation unit for, based on the similarity level calculated by the calculation unit and the state of the customer-service-handling-person diagnosed by the diagnosis unit, generating support necessity information representing a degree of necessity for supporting the customer-service-handling-person.

### TECHNICAL FIELD

The present invention relates to a technique of, when a customer-service-handling-person is in difficulties in customer service, using an information processing device and thereby asking a supporter to support the customer-service-handling-person.

### BACKGROUND ART

In customer service handling in a call center, retail sales of a retail store, or the like, it is very important to promptly and appropriately respond to a question or request from a customer, in order to improve a customer satisfaction level. For example, when a customer-service-handling-person of inexperience handles customer service, or when contents of a question or request from a customer are new ones that have not occurred so far, it becomes difficult to promptly and appropriately handle customer service, which causes degradation of a customer satisfaction level. Therefore, expectation for a technique of supporting prompt and appropriate customer service handling has been increasing.

PTL 1 dilscloses, as a technique related to such a technique, a call center operation system that recognizes emotion between a customer and an operator at a time of responding to the customer, and when the emotion significantly deteriorates, gives a supervisor a notification to that effect. The system records voice data of a conversation between a customer and an operator, and converts the voice data into wording data. The system compares the wording data with a word list in which words expressing emotion are registered in advance, and extracts matched words. The system counts the number of the extracted words for each piece of emotion, thereby converting, into a numeric value, the words expressing the emotion for each piece of emotion. When the numeric value exceeds a predetermined threshold value, the system notifies an administrator terminal that emotion of at least one of the customer and the operator is significantly changing.

PTL 2 discloses a server device that enables a telephone conversation status of an operator and a customer to be easily acquired. The device receives a first voice being a voice of an operator and a second voice being a voice of a customer as a party of a telephone conversation with the operator. The device specifies, from the voice, an emotion degree being a degree of “anger”. The device generates display information for displaying an emotion degree of the operator based on the specified first voice and an emotion degree of the customer based on the specified second voice, and outputs the generated display information.

PTL 3 discloses a call center system. In a situation where, concerning contents of telephone conversations between customers and operators, a supervisor simultaneously monitors a plurality of the telephone conversations, the system enables the supervisor to grasp exchanges between the customers and the operators in real time, and appropriately cope with a trouble and a complaint from the customer. A server device in the system uses a voice recognition device and thereby converts, into a text, a telephone conversation that includes a predetermined keyword and that is recorded for each extension number, and sends the text to a supervisor terminal, along with information such as a telephone conversation state and an operator state. For each operator, in association with the extension number, the supervisor terminal displays, as a balloon, a text including the predetermined keyword, in a display window of a seat diagram of the operators. The supervisor terminal also displays a telephone conversation state, an operator state, and the like. When the balloon of the telephone conversation is clicked, the server device converts the subsequent telephone conversation into a text by using the voice recognition device, and then sends the text to the supervisor terminal, thereby causing the text to be displayed on the supervisor terminal.

### CITATION LIST

### Patent Literature

[PTL 1] Japanese Unexamined Patent Application Publication No. 2016-092582
[PTL 2] Japanese Unexamined Patent Application Publication No. 2015-141428
[PTL 3] Japanese Unexamined Patent Application Publication No. 2016-092582

### SUMMARY OF INVENTION

### Technical Problem

As described in each PTL described above, there is a technique in which a status of emotion or the like between a customer and a customer-service-handling-person is acquired based on contents of a telephone conversation between the customer and the customer-service-handling-person (operator), and when a problem is likely to occur, a supporter (supervisor) who is a skilled person supports the customer-service-handling-person, thereby avoiding a problem. In a system adopting such a technique, for example, when the supporter is asked to provide more support than necessary even though necessity for support is low, there is a possibility that a load on the supporter increases, and an assist to a case of high necessity for support is failed to be provided by the supporter. On the contrary, for example, when the supporter is not asked to provide support even though necessity for support is high, a possibility of occurrence of a problem becomes high, thus causing degradation of a customer satisfaction level. In other words, a problem lies in enhancing accuracy of determining necessity for support, in order to appropriately control support provided by a supporter to a customer-service-handling-person when the customer-service-handling-person is in difficulties in customer service. It cannot be said that the techniques described in PTLs 1 to 3 are sufficient for solving such a problem. A main object of the present invention is to provide a customer service support device and the like that solve the problem.

### Solution to Problem

A customer service support device according to one aspect of the present invention includes: an acquisition means for acquiring customer service information representing a content of a conversation made between a customer and a customer-service-handling-person and representing a state of the customer-service-handling-person; a calculation means for calculating a similarity level between past case information representing a past case concerning the conversation and the customer service information representing a content of the conversation; a diagnosis means for diagnosing a state of the customer-service-handling-person, based on diagnosis criterion information serving as a criterion when diagnosing the state of the customer-service-handling-person, and based on the customer service information; and a generation means for, based on the similarity level calculated by the calculation means and the state of the customer-service-handling-person diagnosed by the diagnosis means, generating support necessity information representing a degree of necessity for supporting the customer-service-handling-person.

From another viewpoint of accomplishing the above-described object, a customer service support method according to one aspect of the present invention includes, by an information processing device: acquiring customer service information representing a content of a conversation made between a customer and a customer-service-handling-person and representing a state of the customer-service-handling-person; calculating a similarity level between past case information representing a past case concerning the conversation and the customer service information representing a content of the conversation; diagnosing a state of the customer-service-handling-person, based on diagnosis criterion information serving as a criterion when diagnosing the state of the customer-service-handling-person, and based on the customer service information; and generating, based on the calculated similarity level and the diagnosed state of the customer-service-handling-person, support necessity information representing a degree of necessity for supporting the customer-service-handling-person.

From a still another viewpoint of accomplishing the above-described object, a customer service support program according to one aspect of the present invention causes a computer to execute: acquisition processing of acquiring customer service information representing a content of a conversation made between a customer and a customer-service-handling-person and representing a state of the customer-service-handling-person; calculation processing of calculating a similarity level between past case information representing a past case concerning the conversation and the customer service information representing a content of the conversation; diagnosis processing of diagnosing a state of the customer-service-handling-person, based on diagnosis criterion information serving as a criterion when diagnosing the state of the customer-service-handling-person, and based on the customer service information; and generation processing of, based on the similarity level calculated by the calculation processing and the state of the customer-service-handling-person diagnosed by the diagnosis processing, generating support necessity information representing a degree of necessity for supporting the customer-service-handling-person.

The present invention may be also achieved by a computer-readable nonvolatile recording medium that stores the customer service support program (computer program).

### Advantageous Effects of Invention

The present invention is able to enhance accuracy of determining necessity for support in a case of, when a customer-service-handling-person is in difficulties in customer service, using an information processing device and thereby asking a supporter to support the customer-service-handling-person.

### BRIEF DESCRIPTION OF DRAWINGS

FIG. 1 is a block diagram illustrating a configuration of a customer service support device 10 according to a first example embodiment of the present invention.

FIG. 2 is a diagram exemplifying contents of support necessity information 140 generated by a generation unit 14 according to the first example embodiment.

FIG. 3 is a diagram exemplifying a mode in which a supporter terminal device 30 according to the first example embodiment of the present invention presents, to a supporter, the support necessity information 140 received from the customer service support device 10.

FIG. 4 is a flowchart illustrating operation of the customer service support device 10 according to the first example embodiment of the present invention.

FIG. 5 is a block diagram illustrating a configuration of a customer service support device 40 according to a second example embodiment of the present invention.

FIG. 6 is a block diagram illustrating a configuration of an information processing device 900 that can implement the customer service support device according to each of the example embodiments of the present invention.

### EXAMPLE EMBODIMENT

The following describes example embodiments of the present invention in detail with reference to the drawings. The present invention is an invention that focuses on determining necessity for support, based on a combination of a degree of similarity with a past case concerning customer service handling and a state of a customer-service-handling-person, thereby enhancing accuracy of the determination.

### First Example Embodiment

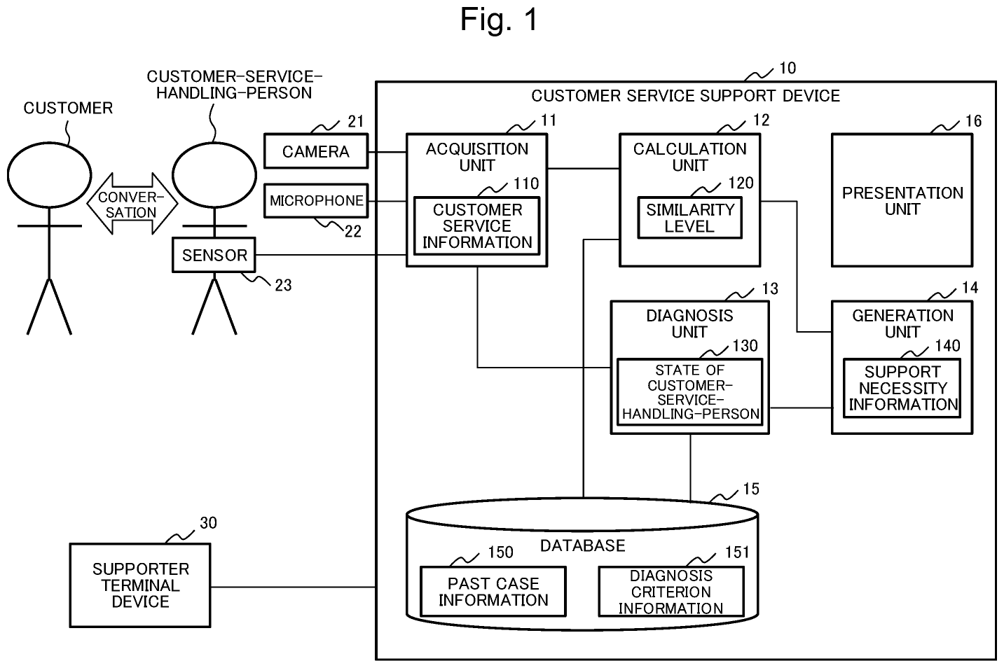

FIG. 1 is a block diagram illustrating a configuration of a customer service support device 10 according to a first example embodiment of the present invention. The customer service support device 10 is an information processing device supporting customer service that is handled by a customer-service-handling-person and that concerns a question or request from a customer, in a call center, a store front of an actual store, or the like. FIG. 1 illustrates one pair of a customer and a customer-service-handling-person for convenience of description, but support targets of the customer service support device 10 may be a plurality of pairs of customers and customer-service-handling-persons.

When a customer-service-handling-person falls into a state of difficulties in customer service and needs support provided by a supporter who is a skilled person, the customer service support device 10 notifies a supporter terminal device 30 being communicably connected to the customer service support device 10 that support is necessary. The supporter terminal device 30 is a terminal device such as a personal computer or a smartphone that can present, to the supporter, information or the like received from the customer service support device 10.

Depending on the notification from the customer service support device 10, the supporter supports the customer-service-handling-person by making, to the customer-service-handling-person, an instruction in a remote environment where the customer service support device 10 and the like are used, or by going to a site where the customer-service-handling-person is handling customer service.

The customer service support device 10 includes an acquisition unit 11, a calculation unit 12, a diagnosis unit 13, a generation unit 14, a database 15, and a presentation unit 16.

The database 15 is constituted of, for example, a nonvolatile storage device such as a magnetic disc, and stores past case information 150 referred to by the customer service support device 10 at the time of operating and stores diagnosis criterion information 151. Details of these pieces of information are described below. The customer service support device 10 does not necessarily need to include the database 15. For example, the database 15 may be structured in a storage device or the like that can be accessed via a communication network by the customer service support device 10.

The acquisition unit 11 acquires, as customer service information 110, image information captured by a camera 21, voice information collected by a microphone 22, and measurement information measured by a sensor 23. For example, the acquisition unit 11 starts operation of acquiring, as the customer service information 110, the above-described image information, voice information, and measurement information after the customer-service-handling-person starts customer service handling. For example, it is assumed that the acquisition unit 11 receives, from an outside, a signal indicating that customer service handling is started (a signal or the like indicating that a response by a telephone is started), and thereby detects that customer service handling is started.

The camera 21 captures an image of a facial expression (e.g., a line of sight) or the like of a customer-service-handling-person. The camera 21 also captures an image of sign language, a body gesture, a hand gesture, or the like performed by the customer-service-handling-person and a customer. The microphone 22 collects voices representing a conversation between the customer and the customer-service-handling-person. When the customer-service-handling-person responds by a telephone in a call center or the like, the microphone 22 collects voices of the telephone. The sensor 23 is a sensor capable of collecting vital data (physical information) representing a physical state of the customer-service-handling-person. The vital data are data representing a heart rate, a blood pressure, a body temperature, or the like, for example.

The acquisition unit 11 analyzes a facial expression or the like of a customer-service-handling-person by performing image recognition processing on image information that is included in the customer service information 110 and that represents the facial expression of the customer-service-handling-person. Since a well-known technique can be applied to the image recognition processing, detailed description thereof is omitted in the present application.

The acquisition unit 11 also performs voice recognition processing on voice information included in the customer service information 110 and representing a conversation between a customer and a customer-service-handling-person, and thereby generates text data (words, a sentence, or sentences) representing the conversation and analyzes a state of an utterance made by the customer-service-handling-person. A state of an utterance is a state concerning a talking speed, loudness of a voice, a rhythm of an utterance, change of a voice, or the like, for example. Since a well-known technique can be applied to the voice recognition processing, detailed description thereof is omitted in the present application. The acquisition unit 11 may also perform image recognition processing on image information representing a conversation (sign language, a gesture, or the like) between the customer and the customer-service-handling-person, and thereby generate one or more words representing the conversation.

The acquisition unit 11 inputs, to the calculation unit 12 and the diagnosis unit 13, the customer service information 110 along with a result (an analysis result or the like) of the above-described processing performed on the customer service information 110. In the present application, the customer service information 110 mentioned hereinafter also includes the performed result of the above-described processing.

The calculation unit 12 calculates a similarity level 120 between conversation contents represented by the past case information 150 acquired from the database 15 and conversation contents represented by the customer service information 110 that is input from the acquisition unit 11 and that includes an analysis result and the like. The past case information 150 is accumulated information of contents (cases) of conversations between customers and customer-service-handling-persons that concerns past customer service handling cases. More specifically, for example, the past case information 150 is information including a pair of a question or request from a customer and a response from a customer-service-handling-person to the question or request, and is structured by text data, for example. The past case information 150 is appropriately updated by input operation performed by a supporter or the like, when a new case is added, or when an already registered case is reviewed, for example.

The calculation unit 12 makes retrieval from the past case information 150 by using, as a retrieval key, a characteristic word, or a sentence or sentences themselves of a question from a customer, being included in a conversation represented by the customer service information 110, and calculates a similarity level 120 between the retrieval key and a case of a conversation included in the past case information 150. The calculation unit 12 calculates a similarity level 120 by performing morphological analysis, syntactic analysis, measurement of a frequency of appearance of the characteristic word, or the like, for example. Since a well-known technique such as the above-described method can be applied to calculation of a similarity level 120, detailed description thereof is omitted in the present application.

The calculation unit 12 specifies a customer service handling case (e.g., having the highest similarity level 120) that is included in the past case information 150 and whose calculated similarity level 120 satisfies a criterion, and inputs, to the generation unit 14, the similarity level 120 concerning the specified customer service handling case.

The past case information 150 may include customer characteristic information that represents a characteristic of a question or request from a customer and that influences a difficulty level of customer service handling. For example, the customer characteristic information is information indicating, from contents of a question from a customer, that the customer has un-abundant knowledge concerning a product field of a question target. Alternatively, for example, the customer characteristic information is information indicating that a request made by a customer is an unreasonable demand. When the customer has un-abundant knowledge of a product field concerning a question target, or when a request made by the customer is an unreasonable demand, a difficulty level of customer service handling is generally high. In other words, for example, the customer characteristic information is information indicating a difficulty level of customer service handling that concerns each customer service handling case.

The calculation unit 12 may extract the customer characteristic information concerning the specified customer service handling case, and input, to the generation unit 14, the extracted customer characteristic information along with the similarity level 120.

The diagnosis unit 13 diagnoses a state 130 of a customer-service-handling-person, based on a state of the customer-service-handling-person represented by the customer service information 110 that includes the analysis result and the like and that is input from the acquisition unit 11, and based on the diagnosis criterion information 151 acquired from the database 15. The diagnosis criterion information 151 is information serving as a criterion at the time of diagnosing whether a customer-service-handling-person is in a normal state or in an abnormal state. For example, an abnormal state refers to a state in which when an inexperienced customer-service-handling-person is in difficulties in customer service, his or her ability of normally handling customer service is reduced due to increase of mental strain.

For example, in the diagnosis criterion information 151, there is registered a characteristic facial expression or behavior that is made by a person in a normal state or in an abnormal state and that is derived from cognitive psychology or the like or is derived by using machine learning based on artificial intelligence. Examples of a facial expression or behavior that is characteristic of a person in an abnormal state include that a line of sight frequently moves, that a value indicated by vital data such as a heart rate or a blood pressure is higher (or lower) than a criterion, that talking is rapid, that loudness of a voice is too large or too small, and that a specific word (e.g., “I can't help it”, “in trouble”, or the like) tending to be uttered in an abnormal state is uttered. The diagnosis criterion information 151 is appropriately updated, by input operation performed by a supporter or the like, based on a result of evaluation performed by a supporter or the like on whether a result of diagnosis performed by the diagnosis unit 13 is appropriate.

The diagnosis criterion information 151 may be information representing a criterion that differs for each customer-service-handling-person. In other words, the diagnosis criterion information 151 may be information for tightening or relaxing a criterion by which a customer-service-handling-person is diagnosed as being an abnormal state, depending on knowledge and a skill level of customer service handling, an actual result of occurrence of a problem in past customer service handling, a tendency of a personality, or/and the like, for each customer-service-handling-person. In this case, the diagnosis criterion information 151 may be information in which identification information capable of identifying a customer-service-handling-person is associated with the diagnosis criterion concerning the customer-service-handling-person, and the diagnosis unit 13 may use the diagnosis criterion specified by the acquired identification information of the customer-service-handling-person.

The diagnosis unit 13 diagnoses a state 130 of a customer-service-handling-person by collating, with the diagnosis criterion information 151, the state 130 of the customer-service-handling-person that is represented by the customer service information 110 input from the acquisition unit 11. The diagnosis unit 13 inputs the diagnosed state 130 of the customer-service-handling-person to the generation unit 14.

Based on a similarity level 120 input from the calculation unit 12 and a state 130 of a customer service handling person input from the diagnosis unit 13, the generation unit 14 generates support necessity information 140 representing a degree of necessity for supporting the customer-service-handling-person.

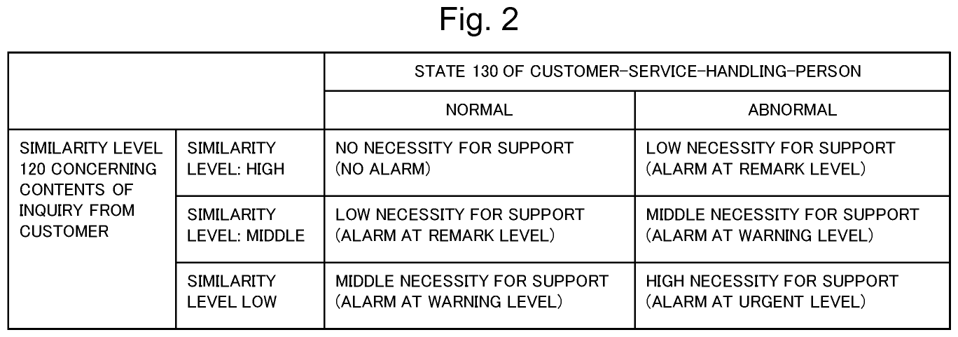

FIG. 2 is a diagram exemplifying contents of the support necessity information 140 generated by the generation unit 14 according to the present example embodiment. In the example illustrated in FIG. 2, the calculation unit 12 calculates a similarity level 120 in three stages (high, middle, or low), and the diagnosis unit 13 diagnoses a state 130 of a customer-service-handling-person in two stages (normal or abnormal). Stages of a similarity level 120 calculated by the calculation unit 12 and stages of a state 130 of a customer-service-handling-person diagnosed by the diagnosis unit 13 are not limited to the example illustrated in FIG. 2. For example, the calculation unit 12 and the diagnosis unit 13 may determine a similarity level 120 and a state 130 of a customer-service-handling-person in stages divided more than in the example illustrated in FIG. 2.

As exemplified in FIG. 2, when a state 130 of a customer service handling person indicates being normal, the generation unit 14 generates support necessity information 140 indicating “no necessity for support (no alarm)”, “low necessity for support (an alarm at a remark level)”, or “middle necessity for support (an alarm at a warning level)”, in this order, depending on “high”, “middle”, or “low” indicated by a similarity level 120. When a state 130 of a customer-service-handling-person indicates being abnormal, the generation unit 14 generates support necessity information 140 indicating “low necessity for support (an alarm at a remark level)”, “middle necessity for support (an alarm at a warning level)”, or “high necessity for support (an alarm at an urgent level)”, in this order, depending on “high”, “middle”, or “low” indicated by a similarity level 120.

In other words, the generation unit 14 generates support necessity information 140 in such a way that necessity for supporting a customer-service-handling-person becomes higher as a similarity level 120 calculated by the calculation unit 12 is lower, or as a state 130 of a customer-service-handling-person diagnosed by the diagnosis unit 13 is more abnormal. For example, the generation unit 14 generates support necessity information 140 in such a way that when a similarity level 120 indicates the same value, necessity for support in the case where a state 130 of a customer-service-handling-person indicates being abnormal is higher than in the case where a state 130 indicates being normal.

When the above-described customer characteristic information is input from the calculation unit 12, the generation unit 14 may generate support necessity information 140, based on a difficulty level of customer service handling indicated by the input customer characteristic information, for example. In other words, when the input customer characteristic information indicates that a difficulty level of customer service handling is high, the generation unit 14 generates support necessity information 140 in such a way that necessity for support becomes higher than in the case where a difficulty level of customer service handling is not high.

The generation unit 14 transmits the generated support necessity information 140 to the supporter terminal device 30. In the case of generating support necessity information 140 in accordance with the illustration in FIG. 2 for example, the generation unit 14 transmits support necessity information 140 to the supporter terminal device 30, except when the support necessity information 140 indicates “no necessity for support (no alarm)”. At this time, to the supporter terminal device 30, the generation unit 14 transmits also additional information representing details of the customer service handling case for which the support necessity information 140 indicates necessity for support.

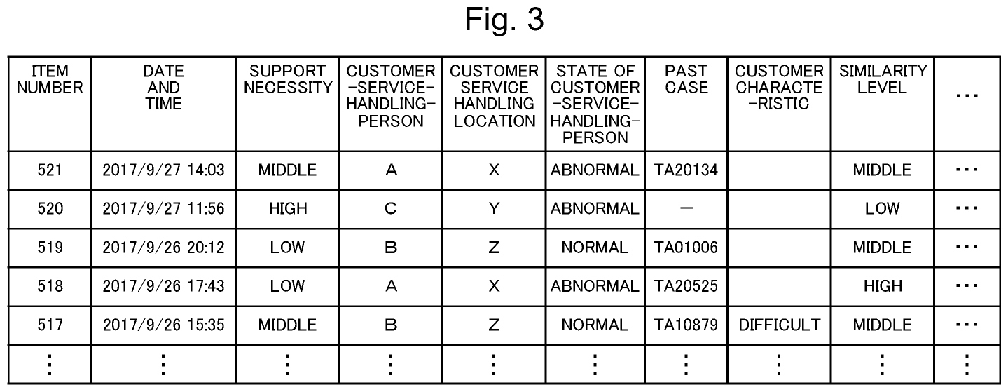

FIG. 3 is a diagram exemplifying a mode in which the supporter terminal device 30 according to the present example embodiment presents (e.g., displays, on a monitor), to the supporter, support necessity information 140 and additional information thereof received from the customer service support device 10. In the example illustrated in FIG. 3, the above-described additional information includes a date and time of transmission to the supporter terminal device 30, identification information of a customer-service-handling-person, a customer service handling location, a state 130 of the customer-service-handling-person, identification information of a past case similar to the customer service handling case, a customer characteristic, a similarity level 120, and the like. As exemplified in FIG. 3, for example, the supporter terminal device 30 displays a history of support necessity information 140 and additional information thereof received from the customer service support device 10.

In the example illustrated in FIG. 3, concerning the item number “517”, a state 130 of a customer-service-handling-person indicates “normal”, a similarity level 120 indicates “middle”, and support necessity information 140 indicates “middle”. As exemplified in FIG. 2, when a state 130 of a customer-service-handling-person is “normal”, and a similarity level 120 is “middle”, the generation unit 14 usually generates support necessity information 140 indicating “low”. This is because as illustrated in FIG. 3, concerning the item number “517”, the customer characteristic described above indicates “difficult” (i.e., a difficulty level of customer service handling is high), and thus, the generation unit 14 generates support necessity information 140 of which support necessity for the item number “517” is raised by one rank.

Based on support necessity information 140 and additional information thereof presented by the supporter terminal device 30, a supporter supports a customer-service-handling-person, prioritizing a customer service handling case in which support necessity is high. In this case, by using the supporter terminal device 30, the supporter notifies the customer service support device 10 of identification information of the customer-service-handling-person who is a support-starting target. Depending on the notification that is received from the supporter terminal device 30 and that indicates a support start, the customer service support device 10 starts to transmit, in real time, to the supporter terminal device 30, image information captured by the camera 21, and voice information collected by the microphone 22, and measurement information measured by the sensor 23, concerning the customer service handling case handled by the customer-service-handling-person. Depending on each of the above-described pieces of information transmitted from the customer service support device 10, the supporter transmits, to the customer service support device 10 via the supporter terminal device 30, information that represents an instruction to the customer-service-handling-person. By video, voice, or the like, the presentation unit 16 in the customer service support device 10 presents, to the customer-service-handling-person, the information that is received from the supporter terminal device 30 and that represents the instruction to the customer service handing person.

Instead of supporting a customer-service-handling-person by using a remote environment as described above, a supporter can also support a customer-service-handling-person by going to a site where the customer-service-handling-person handles customer service (a customer service handling location exemplified in FIG. 3).

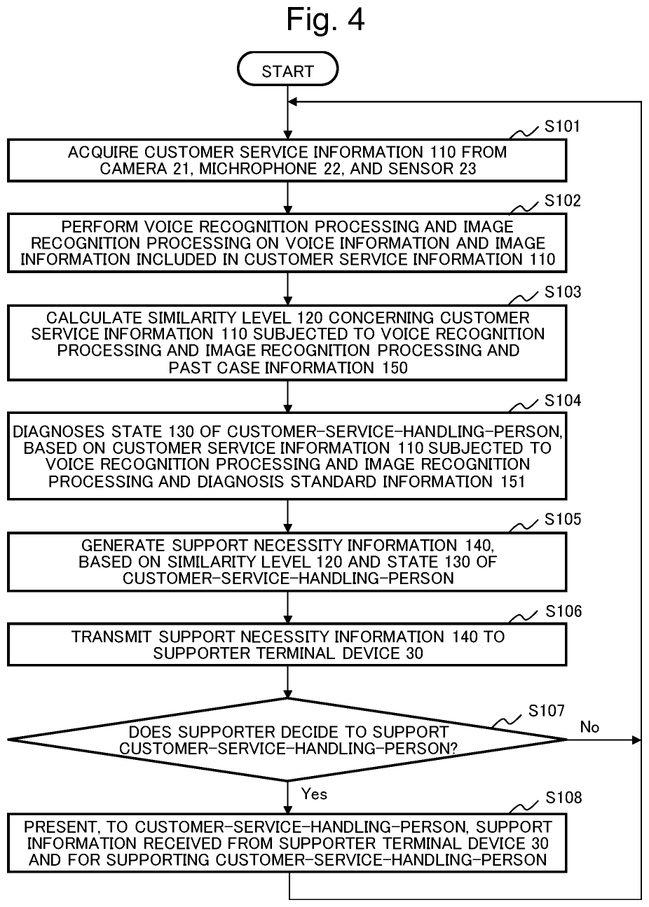

Next, operation (processing) of the customer service support device 10 according to the present example embodiment is described in detail with reference to the flowchart of FIG. 4.

The acquisition unit 11 acquires, as customer service information 110, image information captured by the camera 21, voice information collected by the microphone 22, and measurement information measured by the sensor 23 (step S101). The acquisition unit 11 performs voice recognition processing and image recognition processing on the voice information and the image information included in the customer service information 110 (step S102).

Concerning the customer service information 110 on which the voice recognition processing and the image recognition processing has been performed, and past case information 150, the calculation unit 12 specifies a customer service handling case that is included in the past case information 150 and that is the most similar to the customer service information 110, and calculates a similarity level 120 concerning the specified customer service handling case (step S103). The diagnosis unit 13 diagnoses a state 130 of a customer-service-handling-person by collating, with diagnosis criterion information 151, the customer service information 110 on which the voice recognition processing and the image recognition processing has been performed (step S104). The step S103 and the step S104 may be performed in reversed order, or may be performed in parallel.

Based on the similarity level 120 and the state 130 of the customer-service-handling-person, the generation unit 14 generates support necessity information 140 in such a way that a degree of necessity for supporting the customer-service-handling-person becomes higher as the similarity level 120 is lower, or as the state 130 of the customer-service-handling-person is more abnormal (step S105). The generation unit 14 transmits, to the supporter terminal device 30, the support necessity information 140 along with additional information concerning the customer service handling case for which the support necessity information 140 indicates necessity for support (step S106).

When a supporter presented with the support necessity information 140 transmitted from the customer service support device 10 does not decide to support the customer-service-handling-person (no at a step S107), the processing returns to the step S101. When the supporter presented with the support necessity information 140 transmitted from the customer service support device 10 decides to support the customer-service-handling-person (yes at the step S107), the presenting unit 16 presents, to the customer-service-handling-person, support information that is operationally input by the supporter and is received from the supporter terminal device 30 and that is for supporting the customer-service-handling-person (step S108), and the processing returns to the step S101.

The customer service support device 10 according to the present example embodiment can enhance accuracy of determining necessity for support in the case of, when a customer-service-handling-person is in difficulties in customer service, using an information processing device and thereby asking a supporter to support the customer-service-handling-person. The reason is that the customer service support device 10 generates support necessity information 140, based on a similarity level 120 concerning contents of a conversation made between a customer and a customer-service-handling-person and contents of a conversation indicated by past case information 150, and based on a state 130 of a customer-service-handling-person diagnosed based on diagnosis criterion information 151.

The following is detailed description on advantageous effects achieved by the customer service support device 10 according to the present example embodiment.

There is a technique in which a status of emotion or the like between a customer and a customer-service-handling-person is grasped based on contents of a telephone conversation between the customer and the customer-service-handling-person, and when a problem is likely to occur, a supporter who is a skilled person supports the customer-service-handling-person, thereby avoiding a problem. In a system adopting such a technique, for example, when the supporter is asked to provide more support than necessary even though necessity for support is low, there is a possibility that a load on the supporter increases, and an assist to a case of high necessity for support is failed to be provided by the supporter. On the contrary, for example, when the supporter is not asked to provide support even though necessity for support is high, a possibility of occurrence of a problem becomes high, thus causing degradation of a customer satisfaction level. In other words, a problem lies in enhancing accuracy of determining necessity for support, in order to appropriately ask a supporter to support a customer-service-handling-person when the customer-service-handling-person is in difficulties in customer service.

Elements influencing a degree of necessity for supporting a customer-service-handling-person by a supporter are considered to be roughly classified into two of similarity with a past case concerning contents of customer service handling and a state of a customer-service-handling-person.

First, concerning similarity with a past case, when similarity with the past case concerning contents of customer service handling is high, a customer-service-handling-person may handle customer service by referring to the past case (i.e., a difficulty level of customer service handling is low), and thus, a degree of necessity for supporting the customer-service-handling-person by a supporter tends to be low. In contrast, when similarity with a past case concerning contents of customer service handling is low, a customer-service-handling-person cannot refer to the past case (i.e., a difficulty level of customer service handling is high), and thus a degree of necessity for supporting the customer-service-handling-person by a supporter tends to be high.

Concerning a state of a customer-service-handling-person, in the case where a customer-service-handling-person is in a state (abnormal state) where his or her ability of normally handling customer service is reduced due to increase of mental strain when the customer-service-handling-person is in difficulties in customer service, for example, a degree of necessity for supporting the customer-service-handling-person by a supporter tends to be higher than in the case where the customer-service-handling-person is in a normal state.

Accordingly, a problem is considered to lie in determining a necessity for support, based on a combination of a degree of similarity with a past case concerning customer service handling and a state of a customer-service-handling-person in order to enhance accuracy of determining necessity for support in such a way as to appropriately ask a supporter to support the customer-service-handling-person.

For such a problem, the customer service support device 10 according to the present example embodiment includes the acquisition unit 11, the calculation unit 12, the diagnosis unit 13, and the generation unit 14, and operates as described above with reference to FIG. 1 to FIG. 4, for example. In other words, the acquisition unit 11 acquires customer service information 110 representing contents of a conversation made between a customer and a customer-service-handling-person and a state of the customer-service-handling-person. The calculation unit 12 calculates a similarity level 120 between past case information 150 representing a past case concerning a conversation and the customer service information 110 representing the contents of the conversation. The diagnosis unit 13 diagnoses a state 130 of the customer-service-handling-person, based on diagnosis criterion information 151 serving as a criterion when diagnosing a state of the customer-service-handling-person, and based on the customer service information 110. Based on the similarity level 120 calculated by the calculation unit 12 and the state 130 of the customer-service-handling-person diagnosed by the diagnosis unit 13, the generation unit 14 generates support necessity information 140 representing a degree of necessity for supporting the customer-service-handling-person. Thereby, based on a combination of a degree of similarity with the past case concerning customer service handling and the state of the customer-service-handling-person, the customer service support device 10 according to the present example embodiment determines necessity for support, thus can enhance accuracy of determining necessity for support.

The customer service support device 10 according to the present example embodiment analyzes a state 130 of a customer-service-handling-person, based on diversified information concerning the customer-service-handling-person such as a result of analyzing a facial expression of the customer-service-handling-person, an analysis result concerning a state of an utterance made by the customer-service-handling-person and concerning sentences that represent a conversation with a customer, and vital data of the customer-service-handling-person. Thereby, the customer service support device 10 according to the present example embodiment can grasp a state of the customer-service-handling-person with high accuracy, and thus can enhance accuracy of determining necessity for support.

The customer service support device 10 according to the present example embodiment extracts customer characteristic information from past case information 150 including the customer characteristic information (information indicating a difficulty level of customer service handling that concerns a customer service handling case) that represents a characteristic of a question or request made by a customer, and generates support necessity information 140, based on the extracted customer characteristic information. Thereby, the customer service support device 10 according to the present example embodiment can further enhance accuracy of determining necessity for support.

The customer service support device 10 according to the present example embodiment transmits, to the supporter terminal device 30, support necessity information 140 generated concerning a customer service handling case and additional information representing details of the customer service handling case. Thereby, the customer service support device 10 according to the present example embodiment can implement prompt and appropriate support provided by a supporter to a customer-service-handling-person. As additional information to be transmitted to the supporter terminal device 30, for example, information representing contents of a conversation between a customer and the customer-service-handling-person may be included by the customer service support device 10 in addition to the information illustrated in FIG. 3. In this case, the supporter can grasp specific contents of the customer service handling case in advance, and thus, the service support device 10 can implement more prompt and appropriate support provided by the supporter to the customer-service-handling-person.

### Second Example Embodiment

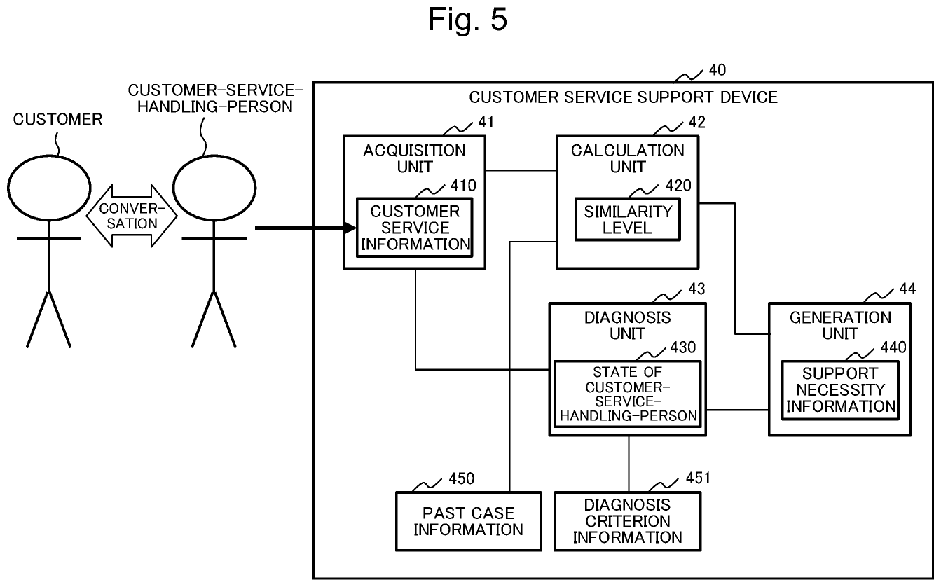

FIG. 5 is a block diagram illustrating a configuration of a customer service support device 40 according to a second example embodiment of the present invention.

The customer service support device 40 according to the present example embodiment includes an acquisition unit 41, a calculation unit 42, a diagnosis unit 43, and a generation unit 44.

The acquisition unit 41 acquires customer service information 410 representing contents of a conversation made between a customer and a customer-service-handling-person and a state of the customer-service-handling-person.

The calculation unit 42 calculates a similarity level between past case information 450 that represents a past case concerning a conversation between a customer and a customer-service-handling-person and customer service information 410 that represents contents of a conversation between a customer and a customer-service-handling-person.

The diagnosis unit 43 diagnoses a state of a customer-service-handling-person, based on diagnosis criterion information 451 serving as a criterion when diagnosing a state of a customer-service-handling-person, and based on the customer service information 410.

Based on the similarity level 420 calculated by the calculation unit 42 and the state 430 of the customer-service-handling-person diagnosed by the diagnosis unit 43, the generation unit 44 generates support necessity information 440 representing a degree of necessity for supporting the customer-service-handling-person.

The customer service support device 40 according to the present example embodiment can enhance accuracy of determining necessity for support in the case of, when a customer-service-handling-person is in difficulties in customer service, using an information processing device and thereby asking a supporter to support the customer-service-handling-person. The reason is that the customer service support device 40 generates support necessity information 440, based on a similarity level 420 concerning contents of a conversation made between a customer and a customer-service-handling-person and contents of a conversation indicated by past case information 450, and based on a state 430 of a customer-service-handling-person diagnosed based on diagnosis criterion information 451.

### <Configuration Example of Hardware>

In each of the above-described example embodiments, each unit in the customer service support device illustrated in FIG. 1 and FIG. 5 can be implemented by dedicated hardware (HW) (an electronic circuit). In FIG. 1 and FIG. 5, at least the following constituents can be regarded as function (processing) units (software modules) of a software program.
Acquisition units 11 and 41
Calculation units 12 and 42
Diagnosis units 13 and 43
Generation units 14 and 44

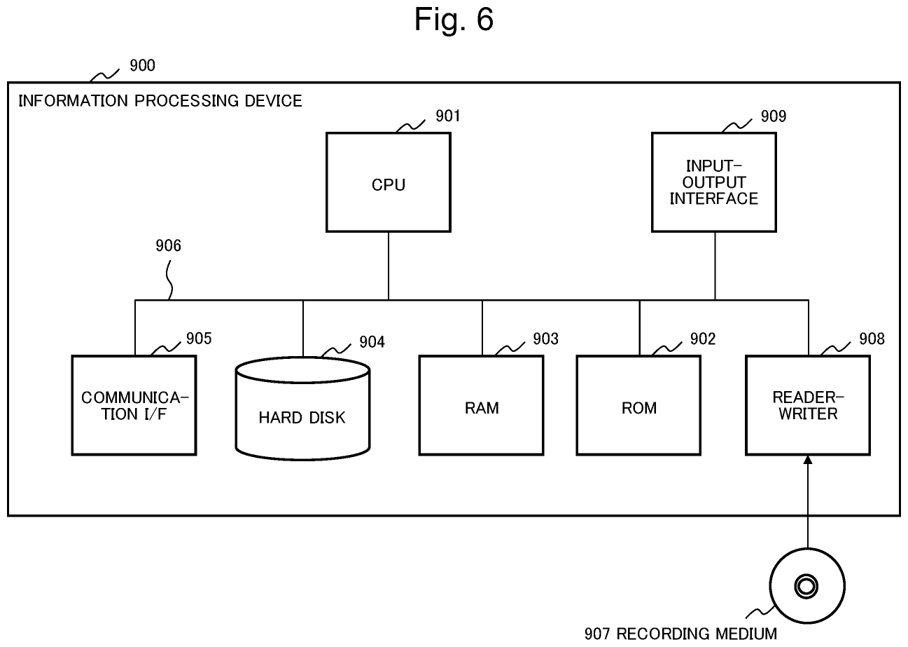

Division of the units illustrated in these drawings indicates a configuration for convenience of description, and various configurations can be supposed in implementation. One example of a hardware environment in this case is described with reference to FIG. 6.

FIG. 6 is a diagram illustrating, as exemplification, a configuration of an information processing device 900 (computer) that can implement the customer service support device according to each of the example embodiments of the present invention. In other words, FIG. 6 represents a configuration of a computer (information processing device) capable of implementing the customer service support device illustrated in FIG. 1 and FIG. 5, i.e., a hardware environment capable of implementing each function in the above-described example embodiment.

The information processing device 900 illustrated in FIG. 6 includes the following as constituent elements.
Central processing unit (CPU) 901
Read only memory (ROM) 902
Random access memory (RAM) 903
Hard disk (storage device) 904
Communication interface 905 with camera 21, microphone 22, sensor 23, supporter terminal device 30, and the like illustrated in FIG. 1
Bus 906 (communication line)
Reader-writer 908 capable of reading and writing data stored in recording medium 907 such as compact disc read only memory (CD-ROM)
Input-output interface 909 including monitor or speaker functioning as presentation unit 16 and input device such as keyboard

In other words, the information processing device 900 including the above-described constituent elements is a general computer in which these constituents are connected to each other via the bus 906. The information processing device 900 includes a plurality of CPUs 901 in some cases, and includes a CPU 901 constituted of multi-cores in other cases.

The present invention by citing the above-described example embodiments as examples provides, to the information processing device 900 illustrated in FIG. 6, a computer program capable of implementing the following functions. The functions are functions of the above-mentioned configuration in the block configuration diagram (FIG. 1 and FIG. 5) referred to in the description of the example embodiment, or are functions in the flowchart (FIG. 4). The present invention is then achieved by reading out the computer program to the CPU 901 of the hardware, and interpreting and executing the computer program. The computer program provided into the device may be stored in a readable and writable volatile memory (RAM 903) or a nonvolatile storage device such as the ROM 902 or the hard disk 904.

In the above-described case, at present, a general procedure can be adopted as a method for providing the computer program into the hardware. Examples of the procedure include a method of installing into the device via various recording media 907 such as a CD-ROM and a method of downloading from an outside via a communication line such as the Internet. In such cases, the present invention can be regarded as being configured by a code constituting the computer program or the recording medium 907 storing the code.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-028137, filed on Feb. 20, 2018, the disclosure of which is incorporated herein in its entirety by reference.

### REFERENCE SIGNS LIST

10 Customer service support device
11 Acquisition unit
110 Customer service information
12 Calculation unit
120 Similarity level
13 Diagnosis unit
130 State of customer-service-handling-person
14 Generation unit
140 support necessity information
15 Database
150 Past case information
151 Diagnosis criterion information
21 Camera
22 Microphone
23 Sensor
30 Supporter terminal device
40 Customer service support device
41 Acquisition unit
410 Customer service information
42 Calculation unit
420 Similarity level
43 Diagnosis unit
430 State of customer-service-handling-person
44 Generation unit
440 Support necessity information
450 Past case information
451 Diagnosis criterion information
900 Information processing device
901 CPU
902 ROM
903 RAM
904 Hard disk (storage device)
905 Communication interface
906 Bus
907 Recording medium
908 Reader-writer
909 Input-output interface

1. A customer service support device comprising:
at least one memory storing a computer program; and
at least one processor configured to execute the computer program to:
acquire customer service information representing a content of a conversation made between a customer and a customer-service-handling-person and representing a state of the customer-service-handling-person;
calculate a similarity level between past case information representing a past case concerning the conversation and the customer service information representing a content of the conversation;
diagnose a state of the customer-service-handling-person, based on diagnosis criterion information serving as a criterion when diagnosing the state of the customer-service-handling-person, and based on the customer service information; and
based on the similarity level calculated by the calculation means and the state of the customer-service-handling-person being diagnosed, generate support necessity information representing a degree of necessity for supporting the customer-service-handling-person.

2. The customer service support device according to claim 1, wherein the processor is configured to execute the computer program to
generate the support necessity information in such a way that the degree of necessity for supporting the customer-service-handling-person becomes higher as the similarity level calculated by the calculation means is lower, or as the state of the customer-service-handling-person diagnosed by the diagnosis means is more abnormal.

3. The customer service support device according to claim 1, wherein the processor is configured to execute the computer program to:
generate one or more words representing the conversation by performing voice recognition processing or image recognition processing on voice information or image information that represents the conversation included in the customer service information; and
calculate the similarity level by performing syntactic analysis on one or more words being generated and one or more words represented by the past case information.

4. The customer service support device according to claim 1, wherein the processor is configured to execute the computer program to:
analyze a facial expression of the customer-service-handling-person by performing image recognition processing on image information representing a facial expression of the customer-service-handling-person, the image information being included in the customer service information; and
diagnose the state of the customer-service-handling-person, based on the diagnosis criterion information representing a facial expression when the customer-service-handling-person is in a normal state or in an abnormal state, and based on a result of analyzing a facial expression concerning the customer-service-handling-person.

5. The customer service support device according to claim 1, wherein the processor is configured to execute the computer program to:
analyze a state of an utterance concerning the conversation and one or more words representing the conversation by performing voice recognition processing on voice information representing the conversation that is included in the customer service information; and
diagnose the state of the customer-service-handling-person, based on the diagnosis criterion information representing the state of the utterance concerning the conversation and representing a specific word included in one or more words representing the conversation, concerning a case where the customer-service-handling-person is in a normal state or in an abnormal state, and based on a result of analysis performed, concerning the state of the utterance concerning the conversation, and one or more words representing the conversation.

6. The customer service support device according to claim 1, wherein
the customer service information includes vital data of the customer-service-handling-person, and
the processor is configured to execute the computer program to
diagnose the state of the customer-service-handling-person, based on the diagnosis criterion information representing the vital data when the customer-service-handling-person is in a normal state or in an abnormal state, and based on the vital data included in the customer service information.

7. The customer service support device according to claim 1, wherein
the past case information includes customer characteristic information representing a characteristic of a question or request from the customer, and
the processor is configured to execute the computer program to:
extract the customer characteristic information from the past case information; and
generate the support necessity information, based on the customer characteristic information being extracted.

8. The customer service support device according to claim 1, wherein the processor is configured to execute the computer program to
transmit, to a supporter terminal device that is communicably connected to the customer service support device and is capable of presenting information to a supporter who supports the customer-service-handling-person, the support necessity information generated for a customer service handling case and additional information representing details of the customer service handling case.

9. A customer service support method comprising, by an information processing device:
acquiring customer service information representing a content of a conversation made between a customer and a customer-service-handling-person and representing a state of the customer-service-handling-person;
calculating a similarity level between past case information representing a past case concerning the conversation and the customer service information representing a content of the conversation;
diagnosing a state of the customer-service-handling-person, based on diagnosis criterion information serving as a criterion when diagnosing the state of the customer-service-handling-person, and based on the customer service information; and
generating, based on the calculated similarity level and the diagnosed state of the customer-service-handling-person, support necessity information representing a degree of necessity for supporting the customer-service-handling-person.

10. A non-transitory computer-readable recording medium that stores a customer service support program for causing a computer to execute:
acquisition processing of acquiring customer service information representing a content of a conversation made between a customer and a customer-service-handling-person and representing a state of the customer-service-handling-person;
calculation processing of calculating a similarity level between past case information representing a past case concerning the conversation and the customer service information representing a content of the conversation;
diagnosis processing of diagnosing a state of the customer-service-handling-person, based on diagnosis criterion information serving as a criterion when diagnosing the state of the customer-service-handling-person, and based on the customer service information; and
generation processing of, based on the similarity level calculated by the calculation processing and the state of the customer-service-handling-person diagnosed by the diagnosis processing, generating support necessity information representing a degree of necessity for supporting the customer-service-handling-person.
